(19) United States
(12) Patent Application Publication
(10) Pub. No.: US 2011/0264142 A1
(43) Pub. Date: Oct. 27, 2011

(54) Teething pacifier

(76) Inventor: Devin A. Reed, Vero Beach, FL (US)

(21) Appl. No.: 12/928,416

(22) Filed: Dec. 10, 2010

Related U.S. Application Data
(60) Provisional application No. 61/284,182, filed on Dec. 14, 2009.

(51) Int. Cl. A61J 17/00

(52) U.S. Cl. 606/235

(57) ABSTRACT

The teething pacifier of the invention is formed with a guard plate having a handle and a chewing plate formed on opposed surfaces thereof. The handle and the chewing plate are substantially co-planar and perpendicular to the plane of the guard plate. The chewing plate is formed with a first and a second lateral segment that are separated by a gap. The teething pacifier is configured for engaging the entire gum line of the infant user and ease teething while providing a soothing sucking device.

### RELATED APPLICATION

This application is a conversion of provisional patent application No. 61/284,182 filed Dec. 14, 2009 which was a continuation-in-part of design patent application Ser. No. 29/316,247 filed Sep. 8, 2009, now abandoned.

### FIELD OF THE INVENTION

The present invention relates to the field of infant teething and pacifier devices.

### BACKGROUND OF THE INVENTION

A pacifier device is intended to be used to calm an infant who is generally upset, in some cases due to the pain of teething. The typical pacifier has a guard plate to prevent the infant from pulling the entire pacifier in their mouth. A small knob is connected on one surface of the guard plate and a handle is connected on the other surface. The knob is formed of a soft material, e.g. molded rubber for being chewed by the infant. The pacifier allows the infant to chew and suck, although without providing nourishment. In addition to soothing the upset infant, the pacifier also provides a chewing exercise for helping new teeth to erupt from the gums.

However, the shape of the typical pacifier as a teething device restricts use for only the front central teeth known as the incisors. Teeth on the sides and toward the rear of the mouth are not aided by chewing on the centrally positioned knob of presently known pacifiers. In addition, if the infant continues to use a pacifier after the incisor teeth have emerged, pressure exerted on the pacifier can cause the top incisors to slant forward and may cause lateral teeth to be moved out of their normal positions.

### SUMMARY OF THE INVENTION

The teething pacifier of the present invention overcomes the drawbacks outlined above by providing a teething device for engaging the entire gum line of the infant. The novel teething pacifier has a flat guard plate with a U-shaped chewing plate extending from one surface and a handle extending from the other surface. The chewing plate is configured to be placed in the infant's mouth, extending from the area of the incisors to the areas of both left and right molars. The chewing plate provides soothing stimulation to all areas of the gums and avoids tooth displacement damage of prior known pacifiers.

### BRIEF DESCRIPTION OF THE DRAWINGS

The present invention is best understood in conjunction with the accompanying drawing figures in which like elements are identified by similar reference numerals and wherein:

FIG. 1 is a perspective view of the teething pacifier of the invention.

FIG. 2 is a top plan view of the teething pacifier of FIG. 1.

### DETAILED DESCRIPTION OF THE PREFERRED EMBODIMENT

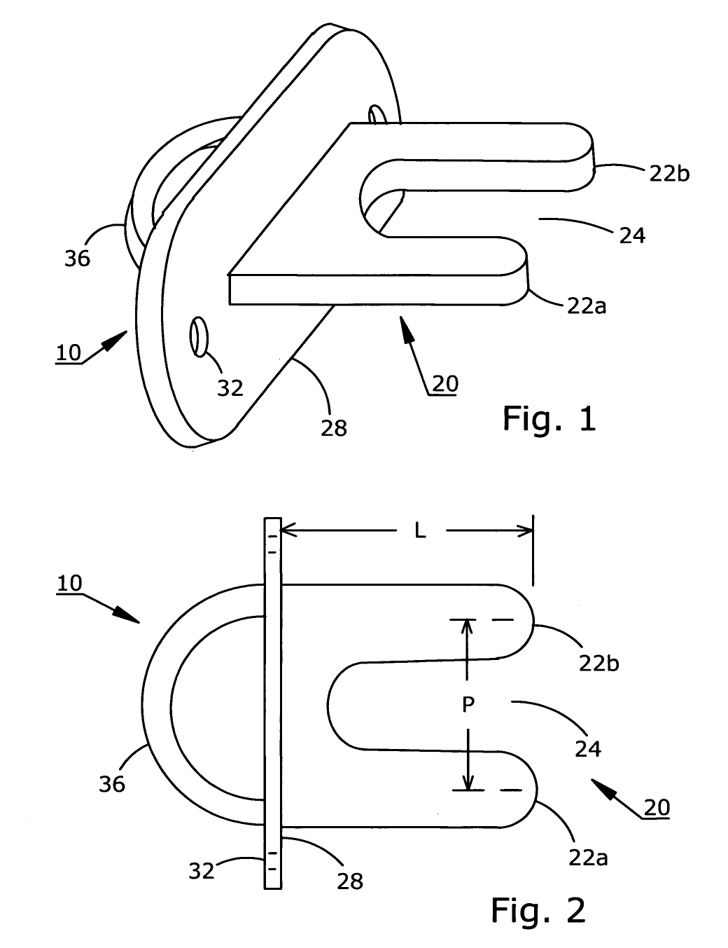

FIGS. 1 and 2 illustrate a teething pacifier 10 of the invention in perspective and top plan views, respectively. Teething pacifier 10 has a chewing plate 20 and a handle 36 that are fixedly connected to one another. Chewing plate 20 and handle 36 are in substantially planar alignment with one another and are connected to opposed surfaces of a guard plate 28 according to the preferred embodiment. Guard plate 28 is oriented substantially perpendicular to the plane of chewing plate 20 and handle 36. Alternate configurations, e.g. chewing plate 20 being oriented at an acute angle to the plane of handle 36 and a configuration with no guard plate, are deemed to be within the scope of the invention. Guard plate 28 is sized to prevent teething pacifier 10 from being pushed entirely into the infant's mouth and throat. Handle 36 is depicted as a semicircular loop, although alternate shapes, e.g. a knob, are available within the present invention.

Chewing plate 20 has two substantially parallel lateral segments 22a and 22b that are separated by a gap 24 sized to allow the infant's tongue to move while chewing plate 20 is in the infant's mouth. Lateral segments 22a and 22b are positioned and sized to engage the gums on each side of the infant's mouth, e.g. where the molars are going to erupt, and apply even and soothing pressure. As seen in FIG. 2, segments 22a and 22b are separated by a pitch distance P, equal to the pitch between left and right rows of teeth in the mouth of a typical infant. Segments 22a and 22b extend outward from guard plate 28 a distance L that is substantially equal to the length from the position of the incisors to the position of the molars in the mouth of a typical infant. The alternate configurations set forth above generally utilize the sizing and spacing of chewing plate 20 as described. Guard plate 28 is formed with one or more holes 32 to enable attachment of a cord or strap (not shown) that can be tied or pinned to the infant's clothing to prevent teething pacifier 10 from falling to the floor. Handle 36, or other handle shape, is sized to allow an adult, or the infant user, to grasp comfortably.

Teething pacifier 10 is preferably formed as an integral unit by the manufacturing process of injection molding. All exposed edges and corners of teething pacifier 10 are to be rounded and all surfaces are to be smooth. Teething pacifier 10 is preferably made of a resilient tough resin material that can be subjected to rigorous cleaning, e.g. food grade silicone resin. The resin for teething pacifier 10 is at any event to be free of biphenyl A (BPA) compound. The density of the molded resin, and therefore the compressibility, may be adjusted according to the intent of the manufacturer.

While the description above discloses preferred embodiments of the present invention, it is contemplated that numerous variations and modifications of the invention are possible and are considered to be within the scope of the claims that follow.

What is claimed is:

1. A teething pacifier, comprising a chewing plate and a handle fixedly connected to one another, the chewing plate having first and second lateral segments separated by an open gap therebetween.

2. The teething pacifier described in claim 1, further comprising a guard plate positioned between the chewing plate and the handle.

3. The teething pacifier described in claim 1, wherein the chewing plate and the handle are substantially co-planar.

4. The teething pacifier described in claim 1, wherein the gap between the first and second lateral segments is sized to allow movement of the tongue of an infant using the pacifier.

5. The teething pacifier described in claim 1, wherein the first and second lateral segments are formed with a pitch distance substantially equal to the distance between lateral rows of teeth in the mouth of a typical infant.

6. The teething pacifier described in claim 1, wherein the first and second lateral segments are formed at a length measured from the guard plate surface that is substantially equal to the length from the position of the incisors to the position of the molars in the mouth of a typical infant.

7. The teething pacifier described in claim 1, wherein the handle is configured as a semicircle.

8. The teething pacifier described in claim 2, further comprising at least one hole formed through the guard plate.

9. The teething pacifier described in claim 1, wherein the pacifier is made from a resilient tough resin material that can be subjected to rigorous cleaning.

10. The teething pacifier described in claim 6, wherein the resin material is a food grade silicone resin.
